(19) United States
(12) Patent Application Publication
(10) Pub. No.: US 2021/0402357 A1
(43) Pub. Date: Dec. 30, 2021

(54) POLYOLEFIN MICROPOROUS MEMBRANE AND LIQUID FILTER

(71) Applicant: Teijin Limited, Osaka-shi, Osaka (JP)

(72) Inventors: Yoshikazu IKUTA, Osaka-shi, Osaka (JP); Koji FURUYA, Osaka-shi, Osaka (JP); Takao OONO, Osaka-shi, Osaka (JP)

(73) Assignee: Teijin Limited, Osaka-shi, Osaka (JP)

(21) Appl. No.: 17/288,989

(22) PCT Filed: Oct. 29, 2019
(86) PCT No.: PCT/JP2019/042303

§ 371 Date: Apr. 27, 2021

(30) Foreign Application Priority Data
Oct. 30, 2018 (JP) 2018-204441

(51) Int. Cl. B01D 69/12; B01D 71/26; B01D 69/02; B32B 27/32; B32B 27/08; C08J 9/26

(52) U.S. Cl. CPC B01D 69/12; C08J 2423/06; B01D 69/02; B32B 27/32; B32B 27/08; C08J 9/26; B01D 2325/028; B01D 2325/24; B01D 2325/04; B32B 2307/54; B32B 2307/732; B32B 2250/03; B32B 2250/242; C08J 2323/06; C08J 2205/044; B01D 71/26

(57) ABSTRACT

An embodiment of the present invention provides a polyolefin microporous membrane, including: a first porous layer containing a polyolefin and having a structure including a first rod-shaped crystal extending in one direction and plural first plate-shaped crystals arranged in a separated state and intersecting the first rod-shaped crystal, and a second porous layer containing a polyolefin and having a structure including a second rod-shaped crystal extending in another direction intersecting the one direction and plural second plate-shaped crystals arranged in a separated state and intersecting the second rod-shaped crystal.

### TECHNICAL FIELD

The present disclosure relates to a polyolefin microporous membrane and a liquid filter.

### BACKGROUND ART

Conventionally, polyolefin microporous membranes have been used in various applications such as liquid filters, moisture permeable waterproof membranes, and air filters.

Production of a polyolefin microporous membrane by a phase separation method or a stretching method are known as typical methods.

The phase separation method is a technique for forming pores by the phase separation phenomenon of a polymer solution and, for example, includes a heat-induced phase separation method in which phase separation is induced by heat, and a non-solvent-induced phase separation method utilizing the solubility characteristics of a polymer for a solvent. Further, it is also possible to combine the techniques of both heat-induced phase separation and non-solvent-induced phase separation, and to further adjust the shape and size of the pore structure by stretching to increase variation.

The stretching method is, as described in Japanese Patent Application Laid-open (JP-A) No. 2010-053245, JP-A No. 2010-202828, JP-A No. H7-246322 and International Publication No. 2014/181760, for example, a method in which a polyethylene raw material sheet formed into a sheet configuration is stretched, stretching conditions such as speed, magnification, and temperature are adjusted to stretch the amorphous part in the crystalline structure, and micropores are formed between lamellar layers while forming microfibrils. Among these, biaxially stretched polyolefin microporous membranes are often used in applications such as liquid filters from the viewpoints of productivity, isotropic properties, uniformity, and the like.

Incidentally, in applications such as liquid filters, gel-like foreign matter made of polymers or the like may be removed as capture targets.

### SUMMARY OF INVENTION

### Problem to be Solved by the Invention

However, gel-like foreign matter is easily deformed, and in a conventional biaxially stretched film such as described in Japanese Patent Application Laid-open (JP-A) No. 2010-053245, JP-A No. 2010-202828, JP-A No. H7-246322 and International Publication No. 2014/181760, not only is clogging prone to occur, but problems such as unfavorable capture of foreign matter and occlusion of pores at the film surface may occur. Therefore, the current state of affairs is that a polyolefin microporous membrane capable of continuously and satisfactorily removing gel-like foreign matter over a long period of time has not yet been proposed.

Therefore, an object of the present disclosure is to provide a polyolefin microporous membrane and a liquid filter having an excellent gel-like foreign matter removal performance and being less susceptible to clogging due to foreign matter.

### Means for Solving the Problem

Specific means for solving the problem include the following aspects.

<1> A polyolefin microporous membrane, including:

a first porous layer containing a polyolefin and having a structure including a first rod-shaped crystal extending in one direction and a plurality of first plate-shaped crystals arranged in a separated state and intersecting the first rod-shaped crystal; and

a second porous layer containing a polyolefin and having a structure including a second rod-shaped crystal extending in another direction intersecting the one direction and a plurality of second plate-shaped crystals arranged in a separated state and intersecting the second rod-shaped crystal.

<2> The polyolefin microporous membrane according to <1>, wherein an average flow pore diameter is from 20 nm to 300 nm.

<3> The polyolefin microporous membrane according to <1> or <2>, comprising a layered structure including at least the first porous layer and the second porous layer, the second porous layer being disposed at both faces of the first porous layer.

<4> The polyolefin microporous membrane according to any one of <1> to <3>, wherein the structure of the first porous layer and the second porous layer comprises a shish-kebab structure including an extended-chain crystal, which is a rod-shaped crystal extending in an axial direction, and a plurality of folded-chain crystals apposed in a separated state and intersecting the extended-chain crystal.

<5> The polyolefin microporous membrane according to any one of <1> to <4>, wherein:

the one direction is a width direction perpendicular to a machine direction, and the other direction is the machine direction; and

a ratio of tensile strength in the machine direction relative to tensile strength in the width direction is from 0.10 to 0.99.

<6> The polyolefin microporous membrane according to any one of <1> to <5>, wherein a flow rate when passing ethanol through the membrane in a thickness direction is from 10 ml/min/cm² to 300 ml/min/cm² as converted under a pressure of 1 MPa.

<7> The polyolefin microporous membrane according to any one of <1> to <6>, having a thickness of from 5 μm to 200 μm.

<8> The polyolefin microporous membrane according to any one of <1> to <7>, having a Gurley value of from 0.1 sec/100 ml to 200 sec/100 ml.

<9> The polyolefin microporous membrane according to any one of <1> to <8>, having a porosity of from 55% to 85%.

<10> The polyolefin microporous membrane according to any one of <1> to <9>, being a base material for a liquid filter.

<11> A liquid filter, comprising the polyolefin microporous membrane according to any one of <1> to <10>.

### Effect of the Invention

According to the present disclosure, it is possible to provide a polyolefin microporous membrane and a liquid filter having an excellent gel-like foreign matter removal performance and being less susceptible to clogging due to foreign matter.

### BRIEF DESCRIPTION OF DRAWINGS

FIG. 1 is a schematic conceptual diagram for explaining the crystalline structure of a polyolefin for forming a polyolefin microporous membrane.

FIG. 2 is a schematic perspective view showing an example of a layered structure of a second porous layer/first porous layer/second porous layer.

FIG. 3 is a schematic perspective view showing a modified example of the layered structure of FIG. 2.

FIG. 4 shows the polyethylene microporous membrane of Example 1, where:

FIG. 4A is a scanning electron microscope (SEM) photograph when the surface layer is observed from the normal direction;

FIG. 4B is an SEM photograph of a cut surface obtained by cutting the polyethylene microporous membrane along the TD; and

FIG. 4C is an SEM photograph of a cut surface obtained by cutting the polyethylene microporous membrane along the MD.

FIG. 5 is an SEM photograph of the surface layer of the polyethylene microporous membrane of Example 2 as observed from the normal direction.

FIG. 6 shows the polyethylene microporous membrane of Example 2, where:

FIG. 6A is an SEM photograph of the surface layer in the TD cross section;

FIG. 6B is an SEM photograph of a central layer in the TD cross section;

FIG. 6C is an SEM photograph of the surface layer in the MD cross section; and

FIG. 6D is an SEM photograph of the central layer in the MD cross section.

FIG. 7 shows the polyethylene microporous membrane of Comparative Example 5, where:

FIG. 7A is an SEM photograph when the surface layer is observed from the normal direction; and

FIG. 7B and FIG. 7C are SEM photographs of respective layers of the polyethylene microporous membrane.

### DESCRIPTION OF EMBODIMENTS

Hereinafter, the polyolefin microporous membrane and the liquid filter of the present disclosure will be described in detail.

The embodiments of the present disclosure described below, the description regarding the embodiments, the examples, and the like, exemplify the polyolefin microporous membrane and the liquid filter of the present disclosure, and do not limit the scope of the present disclosure.

In the present specification, numerical ranges denoted by using “to” indicate a range including the numerical values before and after “to” as the minimum value and the maximum value, respectively. In numerical ranges described in a stepwise manner in the present disclosure, the upper limit value or the lower limit value described in one numerical range may be replaced with the upper limit value or the lower limit value of another numerical range described in a stepwise manner. Further, in the numerical ranges described in the present disclosure, the upper limit value or the lower limit value of the numerical range may be replaced with the values shown in the examples.

Further, with respect to the polyolefin microporous membrane, the “machine direction” means the longitudinal direction (that is, the transport direction) of a polyolefin microporous membrane produced with an elongate shape, and the “width direction” means a direction orthogonal to the machine direction of the microporous polyolefin membrane. Hereinafter, the “width direction” is also referred to as “TD”, and the “machine direction” is also referred to as “MD”.

In numerical ranges described in a stepwise manner in the present specification, the upper limit value or the lower limit value described in one numerical range may be replaced with the upper limit value or the lower limit value of another numerical range described in a stepwise manner. Further, in the numerical ranges described in the present specification, the upper limit value or the lower limit value of the numerical range may be replaced with the values shown in the examples.

Further, in the present disclosure, “% by mass” and “% by weight” are synonymous, and “parts by mass” and “parts by weight” are synonymous.

Further, in the present disclosure, a combination of two or more preferable embodiments constitutes a more preferable embodiment.

In the present disclosure, an amount of each component in a composition or layer means the total amount of the plural substances present in the composition unless otherwise specified, in a case in which plural substances corresponding to each component are present in the composition.

In the present disclosure, the term “process” does not only mean an independent process, but also includes processes that cannot be clearly distinguished from other processes as long as the intended purpose of the process is achieved.

In the present disclosure, the molecular weight when there is a molecular weight distribution represents the weight average molecular weight (Mw) unless otherwise specified.

[Polyolefin Microporous Membrane]

The polyolefin microporous membrane of the present disclosure includes a first porous layer containing a polyolefin and having a structure including a first rod-shaped crystal extending in one direction and plural first plate-shaped crystals arranged in a separated state and intersecting the first rod-shaped crystal, and a second porous layer containing a polyolefin and having a structure including a second rod-shaped crystal extending in another direction intersecting the one direction and plural second plate-shaped crystals arranged in a separated state and intersecting the second rod-shaped crystal.

The polyolefin microporous membrane of the present disclosure may have plural first porous layers and plural second porous layers, respectively, and further, in addition to the first porous layer and the second porous layer, another layer may also be provided.

In the present disclosure, a microporous membrane means a membrane in which interconnected fibrillar polyolefin forms a three-dimensional network structure, the structure having plural micropores internally and the plural micropores being connected to each other so that a gas or a liquid can pass from one surface to the other surface of the membrane.

As discussed above, a biaxially stretched polyolefin microporous membrane is known as a membrane that is used for applications such as liquid filters; however, in general, when applied to remove gel-like foreign matter, issues such as the filter becoming clogged, defective capture, and pore occlusion due to foreign matter are likely to arise, as a result of which, the membrane often cannot withstand long-term use.

In view of such circumstances, in the present disclosure, plural porous layers, having a specific structure including a rod-shaped crystal and plural plate-shaped crystals spaced apart from each other and connected to the rod-shaped crystal, are layered, and the plural porous layers are arranged so that the axial directions of the rod-shaped crystals in the respective layers intersect each other. As a result, it is possible to provide a polyolefin microporous membrane that has a superior capability for removing gel-like foreign matter, and that is less likely to become clogged by foreign matter.

The details of the respective configurations are described below.

(Porous Layer)

The polyolefin microporous membrane of the present disclosure includes at least a first porous layer and a second porous layer, and has a layered structure of two or more layers.

The porous layer is a layer having plural pores internally and having a structure in which adjacent pores are connected to each other so that a gas or a liquid can pass from one surface to another surface.

The polyolefin microporous membrane of the present disclosure may have a layered structure having a first porous layer and a second porous layer and two or more layers of at least one of the first porous layer or the second porous layer, may have a layered structure having two or more first porous layers and two or more second porous layers, and may have a layered structure in which there is an odd number of layers of either the first porous layer or the second porous layer and an even number of layers of the other, and, for example, the following layered structures may be used.

a) First porous layer/second porous layer

b) Second porous layer/first porous layer/second porous layer

c) Second porous layer/first porous layer/second porous layer/first porous layer/second porous layer

Among these, it is preferable to have a layered structure including at least a first porous layer and a second porous layer, in which the second porous layers are arranged on both surfaces of the first porous layer, as shown in b) above.

A case in which the porous layer in the present disclosure has the layered structure of the above-described aspect a) is described as an example.

In aspect a), the first porous layer is a layer having a structure including a first rod-shaped crystal extending in one direction and plural first plate-shaped crystals arranged in a separated state and intersecting the first rod-shaped crystal, and the second porous layer is a layer having a structure including a second rod-shaped crystal extending in another direction intersecting the one direction in the first porous layer, and plural second plate-shaped crystals arranged in a separated state and intersecting with the second rod-shaped crystal. Each of the first porous layer and the second porous layer contains a rod-shaped crystal and plural plate-shaped crystals, and the axial direction of the rod-shaped crystal in the first porous layer and the axial direction of the rod-shaped crystal in the second porous layer intersect each other. That is, while the first porous layer and the second porous layer may be either the same layer or different layers in terms of composition, structure, and the like, the combination of plural porous layers is such that the rod-shaped crystals are at least not parallel to each other.

As a result, when a liquid or the like is passed from one surface of the membrane to the other surface, while ensuring a flow path for liquids and the like between plural plate-shaped crystals arranged apart along the axial direction of the rod-shaped crystal in each porous layer, gel-like foreign matter can be removed at the surface of the plate-shaped crystal or the like. Therefore, the performance in terms of removing gel-like foreign matter is superior, and further, the occurrence of clogging due to foreign matter can be suppressed.

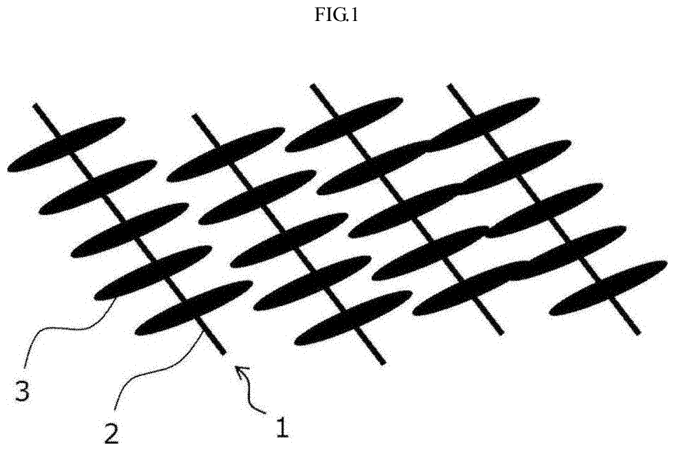

Here, “a structure including a first rod-shaped crystal extending in one direction and plural first plate-shaped crystals arranged in a separated state and intersecting the first rod-shaped crystal” (hereinafter, also referred to as a “specific structure”) is described with reference to FIG. 1.

Structure 1 shown in FIG. 1 is a structure having first rod-shaped crystal 2, which is a rod-shaped crystal in which polyolefin molecules are arranged entirely in one direction; that is, in a uniaxial direction, and first plate-shaped crystal 3, being plural plate-shaped crystals intersecting first rod-shaped crystal 2; that is, connected to the first rod-shaped crystal as if skewered by first rod-shaped crystal 2. The plural plate-shaped crystals (first plate-shaped crystals) are, as shown in FIG. 1, juxtaposed in a state of being separated from each other (a state of intermittent arrangement) along the axial direction of the rod-shaped crystal (first rod-shaped crystal).

As an example of structure 1 shown in FIG. 1, a “shish-kebab” structure may be used.

Shish-kebab structure 1 is a structure including a stretched chain crystal, which is a rod-shaped crystal having one direction as an axis, and plural folded-chain crystals, which intersect the stretched chain crystal and are juxtaposed in a separated state. Specifically, as shown in FIG. 1, the structure has an extended-chain crystal, which is rod-shaped crystal 2 in which polyolefin molecular chains are extended entirely in the uniaxial direction (fiber-shaped crystals referred to as “shish”), and folded-chain crystals (crystals referred to as “kebabs”), which are plural plate-shaped crystals 3 grown so as to surround the extended-chain crystal (shish).

In the extended-chain crystal in the shish-kebab structure, the molecular chain is stretched and oriented in the stretching direction by stretching, and the average distance between rod-shaped crystals represented by the extended-chain crystals (distance between respective axes of rod-shaped crystals) is not particularly limited, but is preferably from 0.5 μm to 20 μm, for example.

Further, as shown in FIG. 1, extended-chain crystals may be connected to each other via a folded-chain crystal extending in a radial direction of the extended-chain crystal axis.

Plate-shaped crystals represented by the folded-chain crystals in the shish-kebab structure are plate-shaped or block-shaped crystal regions having two surfaces (a front surface and a back surface) at which lamellar crystals are grown around an expanded-chain crystal that is stretched and oriented in the stretching direction, and the shape thereof may be flat, squamous, or the like. However, the shape may be any shape having two surfaces, one at the front and one at the back, and is not limited thereto.

The average distance between plate-shaped crystals represented by the folded-chain crystals (distance between respective thickness-dimension centers of plate-shaped crystals), which are arranged separately along the axial direction of the rod-shaped crystal, is not particularly limited, but is preferably from 0.5 μm to 20 μm, for example.

The average value of the angle formed by a rod-shaped crystal represented by an extended-chain crystal and a plate-shaped crystal represented by a folded-chain crystal is, for example, preferably from 30° to 150°, and more preferably from 70° to 110°.

Here, the angle formed by the rod-shaped crystal and the plate-shaped crystal refers to the angle formed by the axial direction of the rod-shaped crystal and the planar direction of the plane of the plate-shaped crystal.

In the foregoing description, “a structure including a first rod-shaped crystal extending in one direction and plural first plate-shaped crystals arranged in a separated state and intersecting the first rod-shaped crystal” in the first porous layer has been described; however, regarding “a structure including a second rod-shaped crystal extending in another direction intersecting the one direction and plural second plate-shaped crystals arranged in a separated state and intersecting the second rod-shaped crystal” in the second porous layer, too, except for the different arrangement angles of the rod-shaped crystals arranged in the respective porous layers, the second rod-shaped crystal and the second plate-shaped crystal are the same as the first rod-shaped crystal and the first plate-shaped crystal, respectively.

The porous layer in the present disclosure is configured by arranging plural polyolefin units having a structure represented by the shish-kebab structure, whereby a porous structure of a polyolefin microporous membrane is formed.

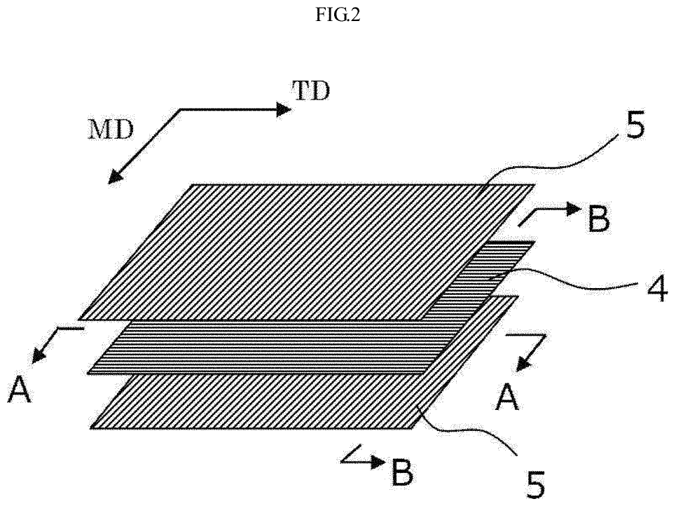

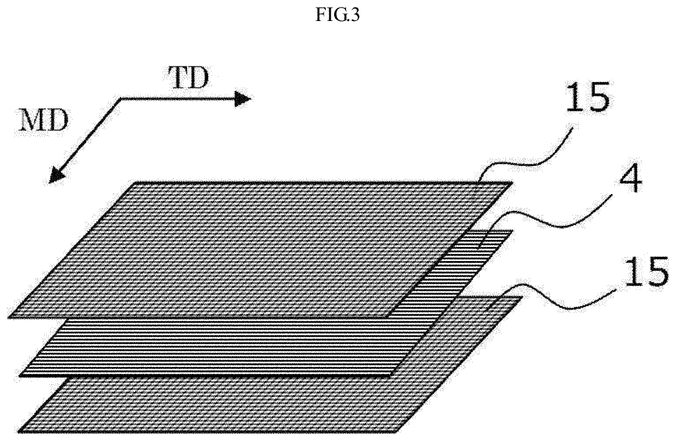

Next, an example of the layered structure of the microporous polyolefin membrane of the present disclosure is described with reference to FIGS. 2 and 3.

FIG. 2 is a schematic perspective view showing an example of a layered structure consisting of second porous layer/first porous layer/second porous layer as indicated in the above-described aspect b), and FIG. 3 is a schematic perspective view showing a modified example of the above-described aspect b).

The microporous polyolefin membrane shown in FIG. 2 is formed with a three-layer structure consisting of a central layer (first porous layer) 4 having a shish-kebab structure including an extended-chain crystal (first rod-shaped crystal) extending along a width direction (TD) orthogonal to a machine direction (MD), and a surface layer (second porous layer) 5 having a shish-kebab structure including an extended-chain crystal (second rod-shaped crystal) extending along the MD, which is provided on both surfaces of the central layer.

As shown in FIG. 1, at the extended-chain crystal, which is the first rod-shaped crystal in the central layer 4, plural folded-chain crystals (first plate-shaped crystals) 3, grown in a configuration as if skewered by the extended-chain crystal 2, are joined (intersect). In addition, at the second rod-shaped crystal, too, which is the extended-chain crystal in the surface layer 5, as shown in FIG. 1, plural folded-chain crystals (second plate-shaped crystals) 3, grown in a configuration as if skewered by the extended-chain crystal 2, are joined (intersect).

The microporous polyolefin membrane shown in FIG. 3 is formed with a three-layer structure consisting of a central layer (first porous layer) 4 having a shish-kebab structure including an extended-chain crystal (first rod-shaped crystal) extending along a width direction (TD) orthogonal to a machine direction (MD), and a surface layer (second porous layer) 15 provided on both surfaces of the central layer and having (1) a first shish-kebab structure, including a first extended-chain crystal (second rod-shaped crystal) extending along the MD, and (2) a second shish-kebab structure including a second extended-chain crystal (second rod-shaped crystal) extending along the TD.

At the extended-chain crystal, which is the first rod-shaped crystal in the central layer 4, similarly to the polyolefin microporous membrane shown in FIG. 2, plural folded-chain crystals (first plate-shaped crystals) 3, grown in a configuration as if skewered by the extended-chain crystal 2, are joined (intersect). Further, at the first extended-chain crystal and the second extended-chain crystal in the surface layer 15, plural folded-chain crystals (second plate-shaped crystals) 3 that intersect each other and, as shown in FIG. 1, that grow in a configuration as if skewered by the extended-chain crystal 2 are joined (intersect).

The production of a polyolefin microporous membrane having a structure such as the three-layer structure described above—that is, a structure including a rod-shaped crystal and plural plate-shaped crystals arranged in a separated state and intersecting the rod-shaped crystal—can, for example, be performed by selecting the stretching method (for example, the stretching direction, such as stretching toward only one of the MD or the TD, the stretching magnification, etc.), the type of solvent used when preparing the polyolefin solution, and conditions such as the heating temperature, in accordance with the target layer structure.

For example, since when stretching is performed, orientation can be configured in the stretching direction, by adjusting the stretching magnification of stretching in one direction, a polyolefin microporous membrane having the structure of, for example, FIG. 2 having a rod-shaped crystal having a desired direction as an axis and a plate-shaped crystal joined to the rod-shaped crystal as if skewered by the rod-shaped crystal, can be obtained. In addition, by selecting an operation to reduce the pore size of the membrane by means of the stretching magnification or the like, a polyolefin microporous membrane having the structure of, for example, FIG. 3 having rod-shaped crystals whose axial directions intersect in a lattice pattern can be obtained.

In the present disclosure, the extended-chain crystal being “along the width direction” means that the axial direction of the extended-chain crystal is in the range of −30° to 30° with respect to the width direction (TD) of the polyolefin microporous membrane. Further, the extended-chain crystal being “along the machine direction” means that the axial direction of the extended-chain crystal is in the range of −30° to 30° with respect to the machine direction (MD) of the polyolefin microporous membrane.

Among the foregoing, when the polyolefin microporous membrane of the present disclosure has the layered structure of second porous layer (surface layer)/first porous layer (central layer)/second porous layer (surface layer), the thickness of the respective layers can be in the following ranges.

The thickness of the central layer is preferably 3 μm to 160 μm.

The thickness of the surface layer at one side is preferably 1 μm to 20 μm.

The structure of the porous layer (for example, the shish-kebab structure) can be confirmed by a scanning electron microscope (SEM).

First, regarding the machine direction (MD) and width direction (TD) of the polyolefin microporous membrane, a sample piece is cut out from a polyolefin microporous membrane produced in elongated form such that the MD and TD are evident, and an SEM photograph of the sample piece is observed. In the observation photograph, the respective directions can be confirmed based on the shape of the sample piece, a marker, and the like.

Further, regarding the layer structure of the porous layer in the polyolefin microporous membrane, a sample piece is cut out from a polyolefin microporous membrane produced in elongated form such that the machine direction (MD) and width direction (TD) are evident, and the crystalline structure can be confirmed by observing an SEM photograph of the sample piece.

(Polyolefin)

Each of the first porous layer and the second porous layer includes at least one type of polyolefin.

As a polyolefin, for example, homopolymers of monomers such as ethylene, propylene, butylene, and methylpentene (polyethylene, polypropylene, polybutylene, polymethylpentene, and the like), or a copolymer of two or more monomers selected from the above-described monomers and the like, or one or more mixtures selected from the above-described homopolymers and copolymers, can be used.

Among these, polyethylene is preferable.

As the polyethylene, high-density polyethylene, a mixture of high-density polyethylene and ultra-high molecular weight polyethylene, and the like, are suitable.

Further, polyethylene and a component other than polyethylene may be used in combination.

Examples of the components other than polyethylene include, for example, polypropylene, polybutylene, polymethylpentene, and copolymers of polypropylene and polyethylene.

Further, plural polyolefins respectively having different properties as polyolefins may be used. That is, plural polyolefins with a combination of degree of polymerization or branchability having poor compatibility with each other—in other words, plural polyolefins having different crystallinity, stretchability and molecular orientation—may be combined.

In regard to the production of a polyolefin microporous membrane, a high molecular weight polyethylene with a weight-average molecular weight of 1 million to 6 million is preferably included at 1% by mass or more in the polyolefin composition.

Among these, in terms of ease of formation of a layered structure having a shish-kebab structure, a polyethylene composition in which a high molecular weight polyethylene with a weight-average molecular weight of 1 million to 6 million and a low molecular weight polyethylene having a weight-average molecular weight of 200,000 or more but less than 1 million are mixed, is preferable.

As the lower limit of the weight-average molecular weight of the high molecular weight polyethylene, 2 million or more is more preferable, and 3 million or more is further preferable. As regards this feature, incorporating an appropriate amount of two or more types of polyethylene has the effect of forming a network-like structure in conjunction with fibrillation during stretching, and increasing the rate of occurrence of pores.

In particular, the mixture ratio (hPE:lPE) of high molecular weight polyethylene (hPE) and low molecular weight polyethylene (lPE) is preferably 1:99 to 70:30 in terms of mass ratio.

In addition, as the low molecular weight polyethylene, a high-density polyethylene having a density of 0.92 g/cm³ to 0.96 g/cm³ is preferable.

The weight-average molecular weight is obtained by heating and dissolving a sample of a polyolefin microporous membrane in o-dichlorobenzene and, by GPC (Alliance GPC 2000 model, column, manufactured by Waters Corporation; GMH6-HT and GMH6-HTL), performing measurement under the conditions of a column temperature of 135° C. and a flow rate of 1.0 mL/min. A molecular weight monodisperse polystyrene (manufactured by Tosoh Corporation) can be used for molecular weight calibration.

The content of polyolefin in each porous layer of the polyolefin microporous membrane is preferably 90% by mass or more with respect to the total mass of each porous layer.

In addition, each porous layer, within a range that does not significantly impair the effects of the present disclosure, may include additives such as an organic filler or inorganic filler and a surfactant as components other than polyolefin.

—Average Flow Pore Diameter—

The polyolefin microporous membrane of the present disclosure preferably has an average flow pore diameter of 20 nm to 300 nm.

Owing to the polyolefin microporous membrane of the present disclosure having an average flow pore diameter in the above range in addition to the above-described porous layer structure, the membrane has a superior gel-like foreign matter removal capability, and the occurrence of clogging due to foreign matter can be suppressed more effectively.

The reason that these effects are achieved by setting the average flow pore diameter in the above range is not clear, but is estimated to be as follows. That is, in a case in which a liquid to be treated containing gel-like foreign matter or the like is passed through a polyolefin microporous membrane having a structure as described above (for example, a shish-kebab structure), while gel-like foreign matter infiltrates the inside of the membrane without occluding pores at the surface of the membrane and is trapped at the kebab region inside the membrane, the shish-kebab structure having a shish portion ensures the passage of the liquid to be treated. As a result, the gel-like foreign matter is suitably removed, and the occurrence of clogging due to foreign matter or the like at the membrane surface is reduced.

When the average flow pore diameter is 20 nm or more, it is difficult for foreign matter to occlude the pores at the membrane surface, and it is easy to suitably maintain the flow of the liquid to be treated. From this perspective, the average flow pore diameter is more preferably 30 nm or more, yet more preferably 40 nm or more, yet more preferably 50 nm or more, and particularly preferably 60 nm or more.

Further, when the average flow pore diameter is 300 nm or less, it is easy to maintain a favorable removal performance of gel-like foreign matter. From this perspective, the average flow pore diameter is more preferably 290 nm or less, yet more preferably 280 nm or less, yet more preferably 270 nm or less, and particularly preferably 200 nm or less.

The method for measuring the average flow pore diameter is as described in the Examples section below.

While the method for adjusting the average flow pore diameter of the porous layer to within the above range is not particularly limited, methods include appropriately adjusting, for example, the composition of the polyolefin, the polyolefin concentration in the raw material for forming the porous layer, the mixing ratio in cases in which plural solvents are mixed in the raw material for forming the porous layer, the heating temperature for squeezing out the solvent inside a sheet extruded into sheet form, the extrusion pressure, the heating time, the stretching magnification, the heat treatment (heat fixing) temperature after stretching, the immersion time in an extraction solvent, the annealing treatment temperature and treatment time, and the like.

—Ratio of Tensile Strength—

The polyolefin microporous membrane of the present disclosure preferably has a ratio of tensile strength in the machine direction (MD) to tensile strength in the width direction (TD) (S^{MD}/S^{TD}) of from 0.10 to 0.99.

When the ratio (S^{MD}/S^{TD}) is 0.99 or less, this is preferable in that the gel capture rate is further improved. While the reason for this is not clear, it is presumed that the ratio (S^{MD}/S^{TD}) reflects the structure of the porous layer. That is, it is presumed that when the strength in the TD is greater than the strength in the MD, pores that are effective for gel capture are formed. From this perspective, the ratio (S^{MD}/S^{TD}) is more preferably 0.94 or less.

Further, when the ratio (S^{MD}/S^{TD}) is 0.1 or more, the ratio of the tensile strength in the MD and the tensile strength in the TD is well balanced, and as a result, it is presumed that clogging is unlikely to occur and the gel capture rate is favorable. From this perspective, the ratio (S^{MD}/S^{TD}) is more preferably 0.2 or more, and particularly preferably 0.3 or more.

The ratio (S^{MD}/S^{TD}) is measured as described in the Examples section below.

—Liquid Permeability—

The polyolefin microporous membrane of the present disclosure preferably has a flow rate when ethanol is circulated in a thickness direction (ethanol flow rate), as converted under a pressure of 1 MPa, of from 10 ml/min/cm² to 300 ml/min/cm².

When the ethanol flow rate of the polyolefin microporous membrane is 10 ml/min/cm² or higher, not only is it easy to ensure the water permeability of the liquid to be treated, but it also becomes easy to ensure stability during liquid flow (for example, stability of power load for maintaining a constant liquid flow rate and stability of liquid flow rate under a constant liquid flow pressure (constant power load)) over the long term. From this perspective, it is suitable for use as a liquid filter.

From the above-described perspective, the ethanol flow rate is more preferably 15 ml/min/cm² or higher.

Further, when the ethanol flow rate is 300 ml/min/cm² or lower, it becomes easy to effectively capture gel-like foreign matter. From this perspective, the ethanol flow rate is more preferably 250 ml/min/cm² or lower, yet more preferably 200 ml/min/cm² or lower, and particularly preferably 100 ml/min/cm² or lower.

The liquid permeability can be evaluated using the liquid permeation amount (Vs) obtained from the ethanol flow rate by the following formula as an index, and the details of the calculation method are as described in the Examples section below.

liquid permeation amount (Vs)=V/(Tl×S) Formula:

V: amount of ethanol [ml]

Tl: permeation time of total amount of ethanol [min]

S: liquid permeation area [cm²] of liquid permeation cell

—Thickness—

The polyolefin microporous membrane of the present disclosure preferably has a thickness of 5 μm to 200 μm.

When the thickness of the polyolefin microporous membrane is 5 μm or more, it is easy to obtain favorable mechanical strength, and it is easy to ensure ease of handling during processing of the polyolefin microporous membrane and durability during long-term use when configured, for example, as a filter cartridge. Further, from the viewpoint of improving the capture performance of gel-like foreign matter, a thicker membrane is advantageous. From this perspective, the thickness of the polyolefin microporous membrane is more preferably 10 μm or more, yet more preferably 15 μm or more, and particularly preferably 20 μm or more.

However, when the thickness of the polyolefin microporous membrane is 200 μm or less, not only is it easy to ensure favorable liquid permeability with a single membrane, but it is also easy to obtain a larger filtration area when configured, for example, as a filter cartridge or the like having a predetermined size. In addition, there is the advantage that the flow rate design and the structural design of the filter when processing the polyolefin microporous membrane can be easily implemented. From this perspective, the thickness of the polyolefin microporous membrane is more preferably 180 μm or less, yet more preferably 150 μm or less, yet more preferably 100 μm or less, and particularly preferably 80 μm or less.

The method of measuring the thickness is as described in the Examples section below.

—Porosity—

The microporous polyolefin membrane of the present disclosure preferably has a porosity of 55% to 85%.

When the porosity of the polyolefin microporous membrane is 55% or more, the liquid permeability becomes favorable and clogging is less likely to occur. From this perspective, the porosity is more preferably 60% or more.

Further, when the porosity is 85% or less, the mechanical strength of the polyolefin microporous membrane becomes favorable, and ease of handling is also improved. In addition, the capture performance with respect to gel-like foreign matter is also improved. From this perspective, the porosity is more preferably 80% or less, and yet more preferably 75% or less.

The porosity (c) of the polyolefin microporous membrane is a value calculated by the following formula.

ε(%)={1−Ws/(ds·t)}×100

Ws: basis weight of polyolefin microporous membrane (g/m)²)

ds: true density of polyolefin (g/cm³)

t: thickness (μm) of polyolefin microporous membrane

—Gurley Value—

The polyolefin microporous membrane of the present disclosure preferably has a Gurley value of 0.1 sec/100 ml to 200 sec/100 ml.

When the Gurley value of the polyolefin microporous membrane is 0.1 sec/100 ml or higher, gel-like foreign matter can be collected favorably. From this perspective, the Gurley value is more preferably 10 sec/100 ml or higher.

Further, when the Gurley value is 200 sec/100 ml or lower, the liquid permeability of the liquid to be treated becomes favorable. This is also preferable from the viewpoint of preventing clogging. From this perspective, the Gurley value is more preferably 150 sec/100 ml or lower, and yet more preferably 100 sec/100 ml or lower.

The method of measuring the Gurley value is as described in the Examples section below.

The polyolefin microporous membrane of the present disclosure can be used as a base material for a liquid filter. The polyolefin microporous membrane may be used as a base material for a liquid filter that has been processed to impart affinity to a target liquid. Further, the microporous polyolefin membrane may be configured in the shape of a cartridge and used as a base material for a liquid filter.

As a base material for a liquid filter, a porous base material such as polytetrafluoroethylene is conventionally known, for example. When the polyolefin microporous membrane of the present disclosure is used as a base material for a liquid filter, compared with conventional porous base materials such as polytetrafluoroethylene, since the affinity with the target liquid is favorable, there is an advantage, for example, that the processing for imparting the affinity between the filter and the target liquid is facilitated. Further, when filling the filter with the target liquid when the filter cartridge is loaded in the filter housing and filtration of the target liquid is started, there is an advantage that air pooling is less likely to occur in the filter cartridge, and the filtration yield of the target liquid is improved. Furthermore, since polyolefins such as polyethylene have, themselves, a low halogen element content, handling of used filter cartridges is facilitated and effects such as reducing the environmental burden can also be expected.

The microporous polyolefin membrane of the present disclosure can also be used for applications other than as a base material for liquid filters, and, for example, it can be expected to be applied to applications such as gas filters, gas-liquid separation membranes, and blood cell separation membranes.

[Method of Producing Microporous Polyolefin Membrane]

The microporous polyolefin membrane of the present disclosure can be favorably produced by the method shown below.

That is, it is preferable to use a manufacturing method in which the following processes (I) to (IV) are sequentially implemented.

(I) A process of preparing a solution containing a polyolefin composition (for example, a polyethylene composition) and a solvent

(II) A process of melt-kneading the prepared solution, extruding the obtained melt-kneaded product from a die, and cooling and solidifying to obtain a gel-like formed product

(III) A process of stretching the gel-like formed product in either the machine direction or the width direction

(IV) A process of washing out a solvent, by extraction, from inside a stretched intermediate formed product

In process (I), a solution containing a polyolefin composition and a solvent is prepared; however, it is preferable to prepare a solution containing a non-volatile solvent having at least a boiling point of 210° C. or higher at atmospheric pressure.

Examples of the non-volatile solvent used for preparing this solution include liquid paraffin, paraffin oil, mineral oil, and castor oil, and liquid paraffin is preferable. Further, for the preparation of the solution, a volatile solvent having a boiling point of less than 210° C. at atmospheric pressure may be used, if necessary. While the volatile solvent is not particularly limited as long as it can swell or dissolve the polyolefin favorably, liquid solvents such as tetralin, ethylene glycol, decalin, toluene, xylene, diethyltriamine, ethylenediamine, dimethyl sulfoxide, and hexane are preferable. The volatile solvent may be used singly or in combination of two or more kinds. Among these, the volatile solvent is preferably decalin or xylene.

In the solution in process (I), the concentration of the polyolefin composition is preferably 10% by mass to 40% by mass, and is more preferably 13% by mass to 25% by mass. When the concentration of the polyolefin composition is 10% by mass or more, since the mechanical strength can be increased, ease of handling is further enhanced, and in addition, it becomes easier to favorably form a polyolefin microporous membrane. Further, when the concentration of the polyolefin composition is 40% by mass or less, there is a tendency for the formation of pores to be facilitated.

In the process (II) the solution prepared in the process (I) is melt-kneaded, and the obtained melt-kneaded product is extruded from a die and cooled and solidified to obtain a gel-like formed product. Preferably, the polyolefin composition is extruded from a die in a temperature range from the melting point of the polyolefin composition to (the melting point+65° C.) to obtain an extruded product, and the obtained extruded product is cooled to obtain a gel-like formed product. The formed product is preferably a formed product that is shaped into sheet form. The cooling may constitute quenching in an aqueous solution or an organic solvent, or casting onto a cooled metal roll. The cooling temperature is preferably 5° C. to 40° C.

It is preferable to prepare a gel-like sheet while preventing solvent released from a sheet that has been gelled in a water bath and floating at the water surface from adhering to the sheet again by providing a water flow at the surface layer of the water bath.

The process (III) is a process of stretching the gel-like formed product in either the machine direction or the width direction.

The stretching in the process (III) is preferably uniaxial stretching in the machine direction (MD) or the width direction (TD) orthogonal to the MD, and it is more preferable to perform uniaxial stretching in the TD without stretching in the MD.

The stretching magnification is preferably from three times to fifty times, and more preferably four times to twenty times. When the stretching magnification is three times or more, not only does it become easier to favorably form a polyolefin microporous membrane, it also becomes easier to form a structure represented by the shish-kebab structure as described above. Further, when the stretching magnification is fifty times or less it is easy to form a structure represented by the shish-kebab structure as described above, and unevenness in thickness tends to be easy to minimize.

Stretching is preferably performed in a state in which the solvent is kept in a favorable state.

The stretching temperature is preferably 80° C. to 140° C., and more preferably 100° C. to 130° C.

Further, a thermal fixing treatment may be performed after the stretching process in the process (III).

The thermal fixing temperature is, from the viewpoint of controlling the liquid permeability of the polyolefin microporous membrane and the removal performance with respect to gel-like foreign matter, which is one target object for filtration, preferably 110° C. to 145° C., and more preferably, 120° C. to 140° C. When the thermal fixing temperature is 145° C. or lower, the removal performance with respect to the filtration target of the polyolefin microporous membrane becomes more favorable, and when the thermal fixing temperature is 110° C. or higher, this is suitable for maintaining the liquid permeability more favorably.

The process (IV) is a process of washing out a solvent, by extraction, from inside a stretched intermediate formed product.

The process (IV), in order to extract the solvent from inside the stretched intermediate formed product (stretched film), preferably performs washing with a solvent of a halogenated hydrocarbon such as methylene chloride or a hydrocarbon such as hexane. In a case of washing by immersion in a tank filled with a solvent, conducting the immersion for a time of 20 seconds to 500 seconds is preferable in that a polyolefin microporous membrane can be obtained with a small amount of elution, and 30 seconds to 500 seconds is more preferable, and 30 seconds to 450 seconds is particularly preferable. Furthermore, in order to enhance the washing effect, it is preferable to divide the tank into several stages, and from the downstream side of the polyolefin microporous membrane conveyance process, pour in the washing solvent, pass the washing solvent toward the upstream side of the conveyance process, and make the purity of the washing solvent in the downstream tank higher than that in the upstream tank.

Further, depending on the required performance of the polyolefin microporous membrane, thermosetting may be performed by means of an annealing treatment. The annealing treatment, from the perspective of ease of conveyance in the process, is preferably performed at 50° C. to 150° C., and is more preferably performed at 50° C. to 140° C.

According to the manufacturing method described above, it is possible to more favorably provide a polyolefin microporous membrane that is a thin film and also has excellent liquid permeability under high pressure and excellent removal performance with respect to a filtration target.

[Liquid Filter]

The liquid filter of the present disclosure includes the above-described microporous polyolefin membrane of the present disclosure. If necessary, it can be configured in the shape of a cartridge or the like for use. Further, the liquid filter may be processed to impart affinity to a target liquid, if necessary.

The liquid filter allows passage of a liquid to be treated containing or being able to contain organic particles, inorganic particles, gel-like matter, and the like, and can remove the particles and gel-like matter from the liquid to be treated.

Further, the liquid filter can be used, for example, in processes such as a semiconductor manufacturing process, a display manufacturing process, or polishing.

[Other Uses]

The polyolefin microporous membrane of the present disclosure is not limited to the above-described liquid filter. For example, it may be used for the purpose of separating, purifying, concentrating, fractionating, detecting, or the like, with respect to a substance dispersed or dissolved in a fluid (that is, a gas or a liquid). Specific examples thereof include various filters used for water purification, sterilization, seawater desalination, dialysis, pharmaceutical production, food production, extracorporeal diagnostic equipment, gas-liquid separation, and the like; chromatography carriers; and the like.

### EXAMPLES

Hereinafter, embodiments of the present disclosure will be described in more detail with reference to examples. However, the present disclosure is not limited to the following examples as long as the gist thereof is not exceeded. Unless otherwise specified, “parts” are based on mass.

The following examples mainly present cases in which a polyethylene microporous membrane is produced as an example of the polyolefin microporous membrane.

[Measurement Methods]

(Structural Analysis of Membrane)

After performing a conductive treatment on a polyethylene microporous membrane, using a scanning electron microscope FE-SEM SU8020 (manufactured by Hitachi High-Tech Corporation), observation was performed at a predetermined magnification (1000 to 25000 times) at an acceleration voltage of 1.0 kV, and the crystal structure of the polymer in the membrane and the MD and TD orientations were analyzed from the observation photographs.

(Tensile Strength)

Using a tensile tester (RTE-1210 manufactured by Orientec Co., Ltd.), a test piece (width: 15 mm, length: 50 mm) obtained by cutting a polyethylene microporous membrane into strips was stretched in the MD and TD, respectively, at a speed of 200 mm/min, and the tensile strength was measured. Based on the measured values, the ratio of the tensile strength in the machine direction to the tensile strength in the width direction was determined.

(Gurley Value)

The Gurley value of an area of 642 mm² of the polyethylene microporous membrane was measured by a method conforming to Japanese Industrial Standard (JIS) P8117.

(Average Flow Pore Diameter)

Using a Palm Porometer Porous Material Automatic Pore Diameter Distribution Measurement System [Capillary Flow Polymer] manufactured by PMI, the average flow pore diameter was measured by applying a pore size distribution measurement test method [half-dry method (ASTM E1294-89)].

The test solution used was perfluoropolyester (trade name: Galwick) (interfacial tension value: 15.9 dyne/cm), the measurement temperature was 25° C., and the measurement pressure was changed in the range of from 0 kPa to 1500 kPa.

(Thickness)

The thickness of the polyethylene microporous membrane was measured at 20 points using a contact-type film thickness meter (manufactured by Mitutoyo Corporation), and the measured values were averaged to obtain the thickness. At this time, the contact terminal used was a columnar model having a bottom surface with a diameter of 0.5 cm, and the measurement pressure was 0.1 N.

(Basis Weight)

The polyethylene microporous membrane was cut out at a size of 10 cm×10 cm to prepare a sample piece, the mass of the sample piece was measured, and the measured mass was divided by the area to obtain the basis weight.

(Porosity)

The porosity (c) of the polyethylene microporous membrane was calculated using the following formula.

ε(%)={1−Ws/(ds·t)}×100

Ws: basis weight of polyolefin microporous membrane (g/m)²)

ds: true density of polyolefin (g/cm³)

t: thickness (μm) of polyolefin microporous membrane

(Weight-Average Molecular Weight of Polyethylene)

The polyethylene microporous membrane was heated and dissolved in o-dichlorobenzene, and the weight-average molecular weight was determined by measurement by GPC (Alliance GPC 2000 type, column; GMH6-HT and GMH6-HTL, manufactured by Waters Corporation) under the conditions of a column temperature of 135° C. and a flow velocity of 1.0 mL/min. A molecular weight monodisperse polystyrene (manufactured by Tosoh Corporation) was used for molecular weight calibration.

(Liquid Permeability (Ethanol Flow Rate))

The polyethylene microporous membrane was immersed in ethanol in advance and dried at room temperature. This polyethylene microporous membrane was placed over a stainless steel liquid-permeable cell (liquid permeation area S cm²) with a diameter of 47 mm. After wetting the polyethylene microporous membrane on the liquid-permeable cell with a small amount (0.5 ml) of ethanol, a pre-measured amount of ethanol V (100 ml) was passed through under a differential pressure of 90 kPa, and the time Tl (min) required for the whole amount of ethanol to permeate was measured. From the liquid amount of ethanol and the time required for ethanol to permeate, the liquid permeation amount Vs per unit time (min) and unit area (cm²) under a differential pressure of 90 kPa was calculated using the following formula, and this was designated as the liquid permeability (ml/min·cm²). The measurement was carried out in a temperature atmosphere of a room temperature of 24° C.

Vs=V/(TI×S)

(Gel Capture Performance/Clogging)

A gel-like liquid was prepared by diluting soymilk (trade name: “Kikkoman, Oishii Unadjusted Soymilk”) with water by 400,000 times.

This polyethylene microporous membrane was placed over a stainless steel liquid-permeable cell with a diameter of 47 mm. After wetting the polyethylene microporous membrane on the liquid-permeable cell with a small amount (0.5 ml) of ethanol, a pre-measured amount of water (20 ml) was passed through under a differential pressure of 90 kPa. After this, the gel-like liquid (20 ml) was repeatedly transmitted and the time T1 (sec) required for the first total amount of the gel-like liquid to permeate and the time T2 (sec) required for the fifth total amount of the gel-like liquid to permeate were measured. From the time required for the first transmission and the time required for the fifth transmission, the rate of increase ΔT % of the permeation time due to gel capture was calculated using the following formula, and this was used as a reference value with respect to capturing gel-like foreign matter and clogging. When the rate of increase was less than 10%, it was evaluated as optimum (A), when it was 10% or more and less than 25%, it was evaluated as favorable (B), and when it was 25% or more, it was evaluated as poor (C).

ΔT %=(T2/T1−1)×100

### Example 1

A polyethylene composition, obtained by mixing 10 parts by mass of high molecular weight polyethylene (PE1) having a weight-average molecular weight of 4.6 million and 7 parts by mass of low molecular weight polyethylene (PE2) having a weight-average molecular weight of 560,000, was used. The polyethylene composition and 83 parts by mass of liquid paraffin prepared in advance were mixed such that the total concentration of polyethylene resin was 17% by mass, and a polyethylene solution was prepared.

This polyethylene solution was extruded into a sheet-shape from a die at a temperature of 150° C., the extruded sheet was cooled in a water bath at 19° C., and furthermore, while preventing mixed solvent released from the gelled sheet in the water bath and floating at the water surface from adhering to the sheet again, a gel-like sheet (base tape) was prepared.

The prepared base tape was conveyed on a roller heated to 90° C. while applying a pressure of 0.06 MPa, and a part of the liquid paraffin was removed from within the base tape. At this time, stretching in the conveyance direction of the base tape (MD) was not performed. Then, the base tape was stretched (transversely stretched) at a temperature of 105° C. in the width direction (TD) by 9 times, and immediately after the transverse stretching, heat treatment (heat fixing) was performed at 136° C.

Next, the heat-fixed base tape was continuously immersed in a methylene chloride bath divided into two tanks for 200 seconds in each tank to extract liquid paraffin. When the side at which the immersion is started is the first tank and the side at which the immersion is finished is the second tank, the purity of the washing solvent in each tank is: (low) first layer <second tank (high). After this, methylene chloride was removed by drying at 40° C., and annealing treatment was performed while conveying the base tape on a roller heated to 120° C.

As described above, a base material for a filter made of a polyethylene microporous membrane (polyolefin microporous membrane) was obtained.

The above-described production conditions are shown in Table 1, and the physical characteristics of the obtained base material for a liquid filter are shown in Table 2.

The physical characteristics of the filter base materials obtained in the Examples and Comparative Examples described below are also shown in Tables 1 and 2 in the same manner.

The structure of the polyethylene microporous membrane obtained as described above was verified by the following method.

Specifically, the obtained polyethylene microporous membrane was observed using an SEM as described above, and the crystalline structure of the polymer in the membrane and the MD and TD orientations were analyzed from the observation photograph.

As a result, it was confirmed that the layer structure of the polyethylene microporous membrane is a layered structure consisting of three layers, and as shown in FIG. 3, it was confirmed that both surfaces of the central layer (first porous layer) each had a surface layer (second porous layer) having (1) a first shish-kebab structure including a first extended-chain crystal extending along the MD and (2) a second shish-kebab structure including a second extended-chain crystal extending along the TD. Further, in the thickness direction, the structure of the membrane was dense at the surface layer side, whereas the structure of the central portion was coarser than that of the surface layer.

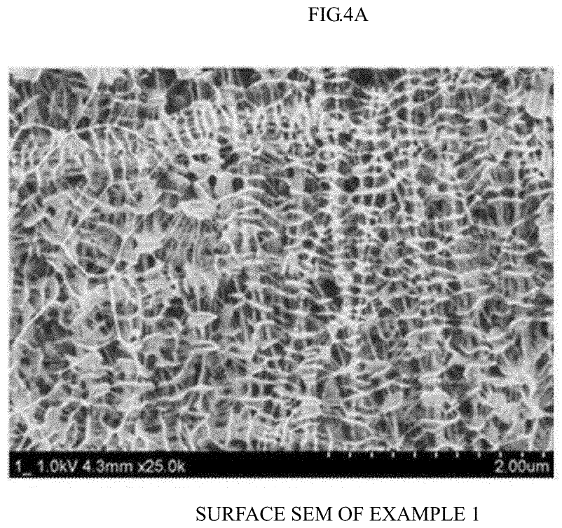

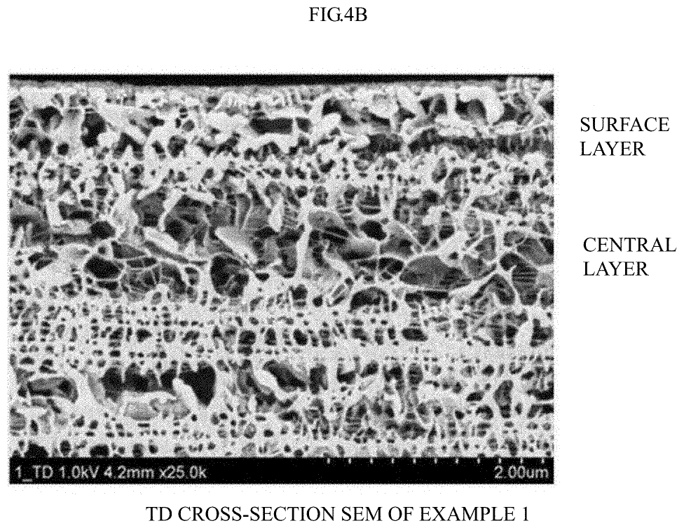

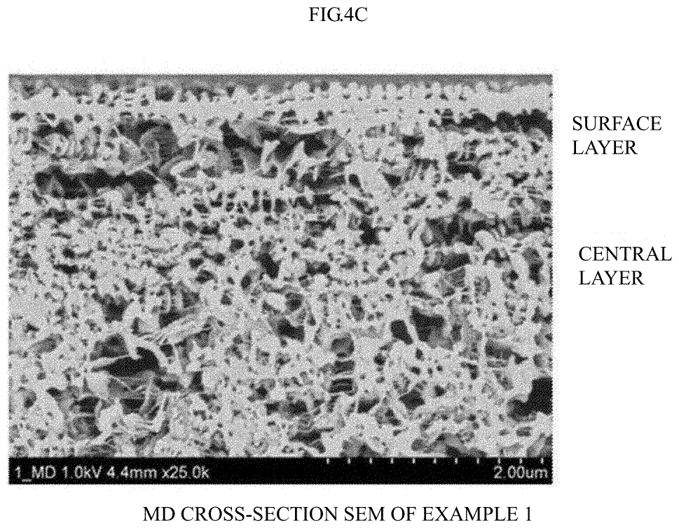

An SEM photograph of each layer is shown in FIG. 4.

FIG. 4A is an SEM photograph of a case in which the surface layer is observed from the normal direction. It is evident that the surface layer has extended-chain crystals, which are rod-shaped crystals that respectively extend in one or other of the MD or TD directions and are oriented so as to intersect each other as shown in FIG. 3. This point was similarly observed on both of the one side and the other side of the polyethylene microporous membrane.

The extended-chain crystal has plural folded-chain crystals, which are plate-shaped crystals that the extended-chain crystal intersects in a skewered manner and that are separated from each other and joined to the extended-chain crystal.

FIG. 4B is an SEM photograph of a cut surface obtained by cutting the polyethylene microporous membrane along the TD. Extended-chain crystals extending along the TD were observed in the surface layer, and extended-chain crystals were also recognized in the central layer.

FIG. 4C is an SEM photograph of a cut surface obtained by cutting the polyethylene microporous membrane along the MD. In the central layer, extended-chain crystals were not observed, and only the plate-shaped crystals (folded-chain crystals) that intersect the extended-chain crystals were observed; however, in the surface layer, extended-chain crystals extending along the MD were observed.

### Examples 2 to 4

Except for the fact that the composition of the solution and the extrusion conditions of Example 1 were changed as shown in Table 1 below, a base material for a liquid filter made of a polyethylene microporous membrane (polyolefin microporous membrane) was obtained in the same manner as in Example 1.

The results of verifying the structure of, among the obtained polyethylene microporous membranes, the polyethylene microporous membrane obtained in Example 2 in the same manner as in Example 1 will be described.

It was confirmed that the layered structure of the polyethylene microporous membrane obtained in Example 2 was a layered structure consisting of three layers, and as shown in FIG. 2, had a central layer (first porous layer) having a shish-kebab structure including extended-chain crystals extending along the TD, and a surface layer (second porous layer) having a shish-kebab structure including an extended-chain crystal extending along the MD, which is provided on both surfaces of the central layer. Further, similarly to Example 1, in the thickness direction, the structure of the membrane was dense at the surface layer side, whereas the structure of the central portion was coarser than that of the surface layer.

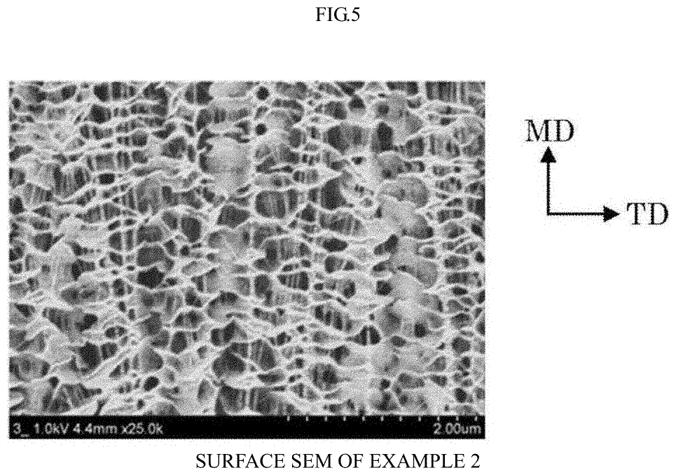

An SEM photograph of the surface layer of the polyethylene microporous membrane is shown in FIG. 5. FIG. 5 is an SEM photograph of a case in which the surface layer is observed from the normal direction.

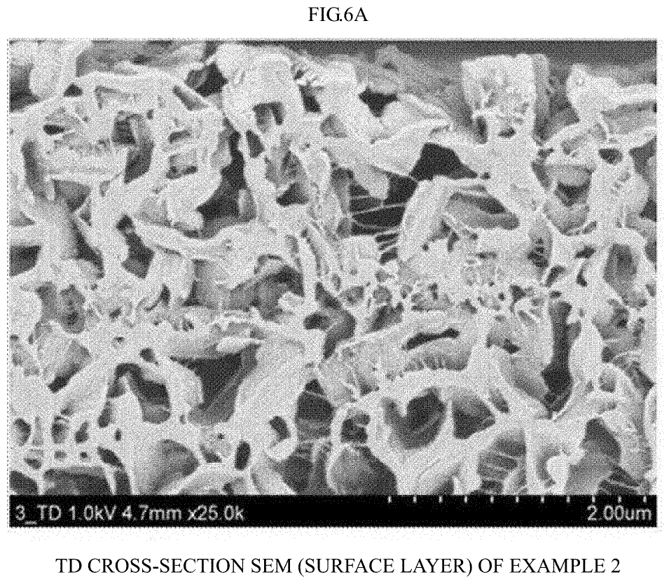

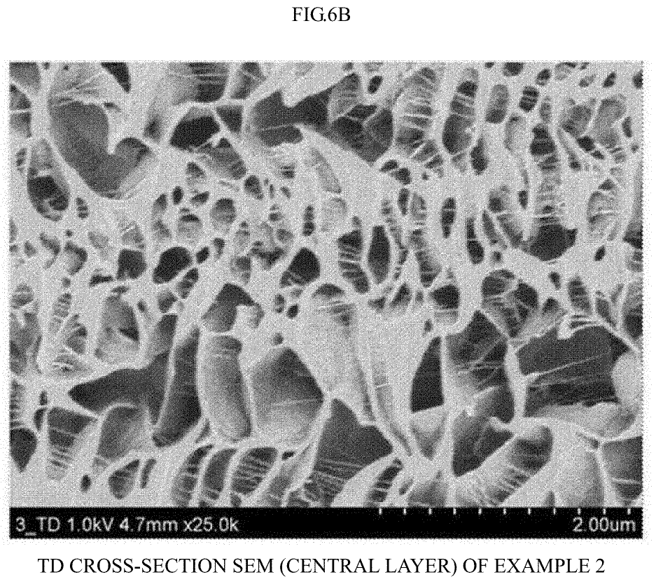

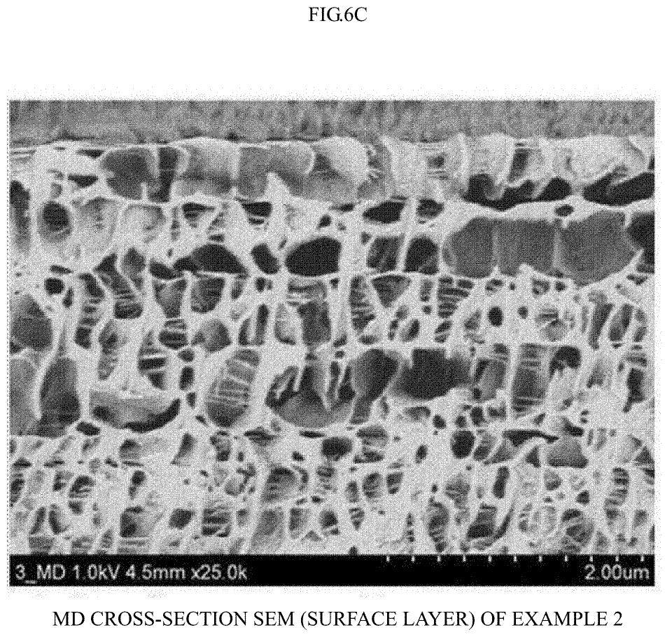

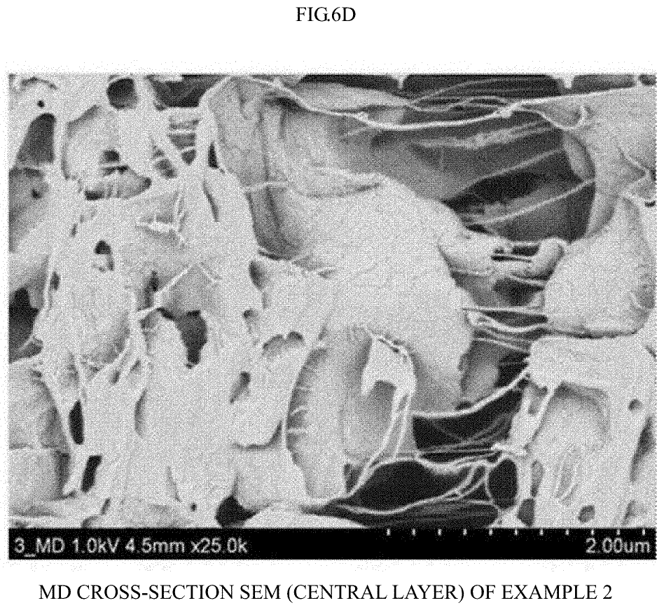

SEM photographs of each layer of the polyethylene microporous membrane are shown in FIG. 6.

Among the cut surfaces (A-A line cross section in FIG. 2) obtained by cutting a polyethylene microporous membrane along the TD, FIG. 6A shows an SEM photograph of the surface layer and FIG. 6B shows an SEM photograph of the central layer. As shown in FIG. 6A, the structure along the TD appears to be mainly configured by folded-chain crystals, which are plate-shaped crystals, in the surface layer, and in the central layer, extended-chain crystals, which are rod-shaped crystals, were mainly observed.

Among the cut surfaces (B-B line cross section in FIG. 2) obtained by cutting a polyethylene microporous membrane along the MD, FIG. 6C shows an SEM photograph of the surface layer and FIG. 6D shows an SEM photograph of the central layer. As shown in FIG. 6C, the structure along the MD appears to be mainly configured by extended-chain crystals, which are rod-shaped crystals, in the surface layer, and in the central layer, folded-chain crystals, which are plate-shaped crystals, were mainly observed.

It was confirmed that the layered structure of the polyethylene microporous membranes obtained in Examples 3 and 4 also had the same three-layer structure as Example 2.

### Comparative Example 1

A polyethylene composition, obtained by mixing 14 parts by mass of high molecular weight polyethylene (PE1) having a weight-average molecular weight of 4.6 million and 11 parts by mass of low molecular weight polyethylene (PE2) having a weight-average molecular weight of 560,000, was used. A polyethylene composition and 75 parts by mass of decalin (decahydronaphthalene) prepared in advance were mixed such that the total concentration of polyethylene resin was 25% by mass, and a polyethylene solution was prepared.

This polyethylene solution was extruded into a sheet-shape from a die at a temperature of 154° C., and the extruded sheet was cooled in a water bath at 20° C. to prepare a gel-like sheet (base tape).

The prepared base tape was pre-dried in a temperature atmosphere of 60° C. for 5 minutes and in a temperature atmosphere of 70° C. for 5 minutes, after which primary stretching was performed by 1.5 times in the conveyance direction (MD) of the base tape. Then, the main drying was performed for 5 minutes in a temperature atmosphere of 57° C. (the residual amount of solvent in the base tape at this time was less than 1% by mass). After the main drying was completed, the base tape was further stretched (longitudinal stretching) in the MD at a temperature of 95° C. by 6.0 times as secondary stretching. Subsequently, it was stretched (transversely stretched) in the width direction (TD) at a temperature of 130° C. by 9.0 times. Immediately after the transverse stretching, heat treatment (heat fixing) was performed at 132° C.

Next, the heat-fixed base tape was continuously immersed in a methylene chloride bath divided into two tanks for 30 seconds in each tank. Then, methylene chloride was removed by drying at 40° C.

As described above, a base material for a liquid filter made of a polyethylene microporous membrane for use in comparison was obtained.

### Comparative Examples 2 and 3

Except for the fact that the composition of the solution and the extrusion conditions of Comparative Example 1 were changed as shown in Table 1 below, a base material for a liquid filter made of a polyethylene microporous membrane was obtained in the same manner as in Comparative Example 1.

### Comparative Example 4

A polyethylene composition, obtained by mixing 3 parts by mass of high molecular weight polyethylene (PE1) having a weight-average molecular weight of 4.6 million and 14 parts by mass of low molecular weight polyethylene (PE2) having a weight-average molecular weight of 560,000, was used. The polyethylene composition and a mixed solvent of 51 parts by mass of liquid paraffin and 32 parts by mass of decalin (decahydronaphthalene) prepared in advance were mixed such that the total concentration of polyethylene resin was 17% by mass, and a polyethylene solution was prepared.

This polyethylene solution was extruded into a sheet-shape from a die at a temperature of 162° C., the extruded sheet was cooled in a water bath at 22° C., and while preventing mixed solvent released from the gelled sheet in the water bath and floating at the water surface from adhering to the sheet again, a gel-like sheet (base tape) was prepared.

The prepared base tape was dried in a temperature atmosphere of 60° C. for 5 minutes and in a temperature atmosphere of 95° C. for 5 minutes, and decalin was removed from within the base tape. Subsequently, the base tape was conveyed on a roller heated to 90° C. while applying a pressure of 0.2 MPa, and a part of the liquid paraffin was removed from within the base tape.

Then, the base tape was stretched (longitudinally stretched) at a temperature of 90° C. by 5.5 times in the conveyance direction (MD) of the base tape, after which, it was stretched (transversely stretched) in the width direction (TD) at a temperature of 106° C. by 10 times. Immediately after the transverse stretching, heat treatment (heat fixing) was performed at 140° C.

Next, the heat-fixed base tape was continuously immersed in a methylene chloride bath divided into two tanks for 60 seconds in each tank to extract liquid paraffin. Further, when the side at which the immersion is started is the first tank and the side at which the immersion is finished is the second tank, the purity of the washing solvent is: (low) first layer <second tank (high). After this, methylene chloride was removed by drying at 40° C., and annealing treatment was performed while conveying the base tape on a roller heated to 120° C.

As described above, a base material for a liquid filter made of a polyethylene microporous membrane for use in comparison was obtained.

### Comparative Example 5

A polyethylene composition, obtained by mixing 10 parts by mass of high molecular weight polyethylene (PE1) having a weight-average molecular weight of 4.6 million and 7 parts by mass of low molecular weight polyethylene (PE2) having a weight-average molecular weight of 560,000, was used. The polyethylene composition and 83 parts by mass of liquid paraffin prepared in advance were mixed such that the total concentration of polyethylene resin was 17% by mass, and a polyethylene solution was prepared.

This polyethylene solution was extruded into a sheet-shape from a die at a temperature of 150° C., the extruded sheet was cooled in a water bath at 19° C., and while preventing mixed solvent released from the gelled sheet in the water bath and floating at the water surface from adhering to the sheet again, a gel-like sheet (base tape) was prepared.

Without partially removing a part of the liquid paraffin from, transversely stretching, or heat-fixing the prepared base tape, the base tape was continuously immersed in a methylene chloride bath divided into two tanks for 200 seconds in each tank, and the liquid paraffin was extracted from the prepared base tape. Further, when the side at which the immersion is started is the first tank and the side at which the immersion is finished is the second tank, the purity of the washing solvent is: (low) first layer <second tank (high). After this, methylene chloride was removed by drying at 40° C., and annealing treatment was performed while conveying the base tape on a roller heated to 120° C.

Then, the base tape was stretched (transversely stretched) at a temperature of 105° C. in the width direction (TD) by 9 times, and immediately after this, heat treatment (heat fixing) was performed at 136° C.

However, a large amount of liquid paraffin remains in the polyethylene microporous membrane produced as described above, and it was not possible to obtain a membrane that can be used as a base material for a liquid filter.

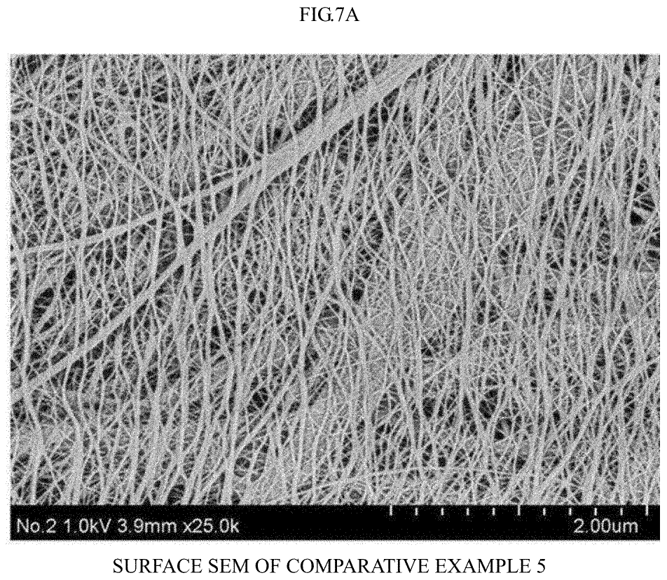

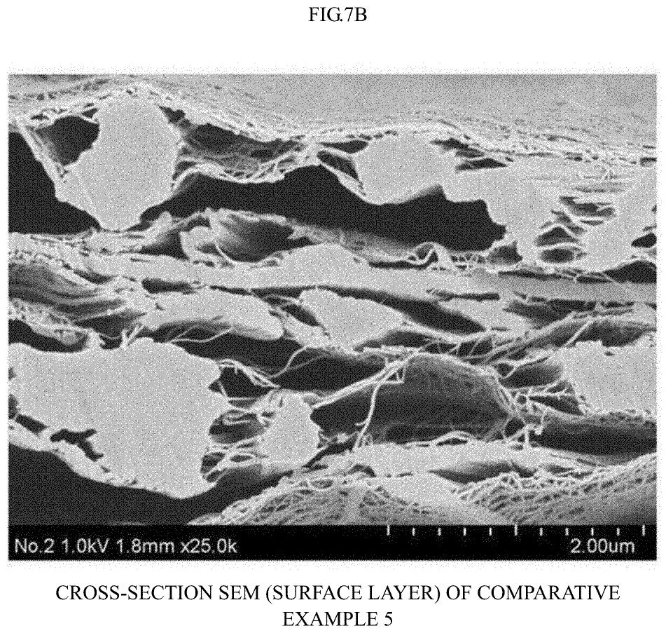

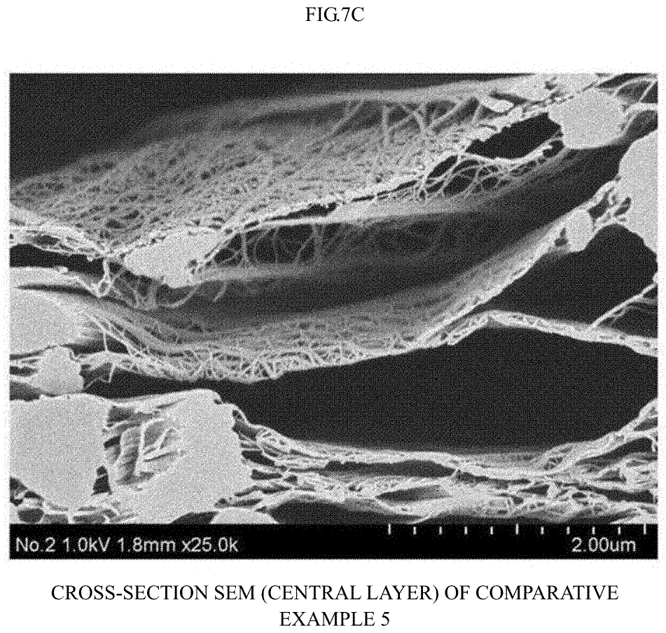

The polyethylene microporous membrane obtained in Comparative Example 5 is shown in FIG. 7. FIG. 7A is an SEM photograph of a case in which the surface layer is observed from the normal direction. SEM photographs of each layer of this polyethylene microporous membrane are shown in FIG. 7B and FIG. 7C.

The polyethylene microporous membrane obtained in Comparative Example 5 has rod-shaped crystals extending in any given direction in a branching configuration, and the structure was not such that the rod-shaped crystals were oriented in one direction. Further, as shown in FIGS. 7B and 7C, plate-shaped crystals joined to rod-shaped crystals, as if being skewered by the rod-shaped crystals extending in any direction in a branching configuration—that is, crystals having two surfaces: one at the front and one at the back—were not observed in either the surface layer or the central layer, and a shish-kebab structure could not be identified.

TABLE 1

| | | | | | | Comparative |
|---|---|---|---|---|---|---|
| | | Example 1 | Example 2 | Example 3 | Example 4 | Example 1 |
| Composition | Decalin (parts by mass) | — | — | — | — | 75 |
| of Solution | Paraffin (parts by mass) | 83 | 83 | 83 | 83 | — |
| | PE concentration (% by mass) | 17 | 17 | 17 | 17 | 25 |
| | PE1 (parts by mass) | 10 | 7 | 3 | 3 | 14 |
| | PE1 Mw | 4.6 million | 4.6 million | 4.6 million | 4.6 million | 4.6 million |
| | PE2 (parts by mass) | 7 | 10 | 14 | 14 | 11 |
| | PE2 Mw | 560,000 | 560,000 | 560,000 | 560,000 | 560,000 |
| | PE1/(PE1 + PE2) (mass ratio) | 0.59 | 0.41 | 0.18 | 0.18 | 0.56 |
| Extrusion | Die temperature (° C.) | 150 | 156 | 151 | 151 | 154 |
| | Cooling temperature (° C.) | 19 | 14 | 18 | 7 | 20 |
| | First drying temperature (° C.) | — | — | — | — | 60 |
| | First drying time (min) | — | — | — | — | 5 |
| | Second drying temperature (° C.) | — | — | — | — | 70 |
| | Second drying time (min) | — | — | — | — | 5 |
| | Primary stretching magnification (times) | — | — | — | — | 1.5 |
| | Main drying temperature (° C.) | — | — | — | — | 57 |
| | Main drying time (min) | — | — | — | — | 5 |
| Stretching | Longitudinal stretching temperature (° C.) | (90) | (90) | (90) | (90) | 95 |
| | Longitudinal stretching magnification (times) | (1.0) | (1.0) | (1.0) | (1.0) | 6.0 |
| | Transverse stretching temperature (° C.) | 105 | 105 | 105 | 105 | 130 |
| | Transverse stretching magnification (times) | 9 | 5 | 5 | 5 | 9 |
| | Heat fixing temperature (° C.) | 136 | 136 | 131 | 130 | 132 |
| Extraction | Extraction time (sec) | 200 | 200 | 170 | 170 | 30 |
| | Drying temperature (° C.) | 40 | 40 | 40 | 40 | 40 |
| | Annealing temperature (° C.) | 120 | 120 | 120 | 120 | — |

| | | Comparative | Comparative | Comparative | Comparative |
|---|---|---|---|---|---|
| | | Example 2 | Example 3 | Example 4 | Example 5 |
| Composition | Decalin (parts by mass) | 75 | 75 | 32 | — |
| of Solution | Paraffin (parts by mass) | — | — | 51 | 83 |
| | PE concentration (% by mass) | 25 | 25 | 17 | 17 |
| | PE1 (parts by mass) | 8 | 8 | 3 | 10 |
| | PE1 Mw | 4.6 million | 4.6 million | 4.6 million | 4.6 million |
| | PE2 (parts by mass) | 17 | 17 | 14 | 7 |
| | PE2 Mw | 560,000 | 560,000 | 560,000 | 560,000 |
| | PE1/(PE1 + PE2) (mass ratio) | 0.32 | 0.32 | 0.18 | 0.59 |
| Extrusion | Die temperature (° C.) | 156 | 148 | 162 | 150 |
| | Cooling temperature (° C.) | 20 | 22 | 22 | 19 |
| | First drying temperature (° C.) | 60 | 60 | 60 | — |
| | First drying time (min) | 5 | 5 | 5 | — |
| | Second drying temperature (° C.) | 70 | 70 | 95 | — |
| | Second drying time (min) | 5 | 5 | 5 | — |
| | Primary stretching magnification (times) | 1.1 | 1.6 | — | — |
| | Main drying temperature (° C.) | 57 | 57 | — | — |
| | Main drying time (min) | 5 | 5 | — | — |
| Stretching | Longitudinal stretching temperature (° C.) | 90 | 90 | 90 | — |
| | Longitudinal stretching magnification (times) | 6.1 | 4.5 | 5.5 | — |
| | Transverse stretching temperature (° C.) | 130 | 125 | 106 | — |
| | Transverse stretching magnification (times) | 9 | 9 | 10 | — |
| | Heat fixing temperature (° C.) | 139 | 147 | 140 | — |
| Extraction | Extraction time (sec) | 30 | 40 | 60 | 200 |
| | Drying temperature (° C.) | 40 | 40 | 40 | 40 |
| | Annealing temperature (° C.) | — | 120 | 120 | 120 |

TABLE 2

| | | | | | Comparative |
|---|---|---|---|---|---|
| | Example 1 | Example 2 | Example 3 | Example 4 | Example 1 |
| Thickness (μm) | 23 | 50 | 45 | 46 | 40 |
| Porosity (%) | 63 | 70 | 70 | 74 | 81 |
| Average flow pore diameter dₚₚ (nm) | 64 | 99 | 126 | 147 | 66 |
| Gurley value (sec/100 ml) | 70 | 73 | 45 | 41 | 40 |
| Tensile strength ratio (MD/TD) | 0.33 | 0.94 | 0.77 | 0.63 | 1.35 |
| Liquid permeability (ml/min · cm²) | 17 | 35 | 60 | 74 | 19 |
| With or without specific structure in first porous layer | Shish-kebab | Shish-kebab | Shish-kebab | Shish-kebab | None |
| With or without specific structure in second porous | Shish-kebab | Shish-kebab | Shish-kebab | Shish-kebab | None |
| layer | | | | | |
| Angle of intersection between axial direction of rod- | 90 | 90 | 90 | 90 | — |
| shaped crystal in first porous layer and axial direction | | | | | |
| of rod-shaped crystal in second porous layer | | | | | |
| Clogging | A | A | B | B | C |

| | Comparative | Comparative | Comparative |
|---|---|---|---|
| | Example 2 | Example 3 | Example 4 |
| Thickness (μm) | 31 | 34 | 12 |
| Porosity (%) | 81 | 79 | 56 |
| Average flow pore diameter dₚₚ (nm) | 198 | 285 | 59 |
| Gurley value (sec/100 ml) | 15 | 10 | 60 |
| Tensile strength ratio (MD/TD) | 1.72 | 2.68 | 0.90 |
| Liquid permeability (ml/min · cm²) | 73 | 158 | 16 |
| With or without specific structure in first porous layer | None | None | None |
| With or without specific structure in second porous | None | None | None |
| layer | | | |
| Angle of intersection between axial direction of rod- | — | — | — |
| shaped crystal in first porous layer and axial direction | | | |
| of rod-shaped crystal in second porous layer | | | |
| Clogging | C | C | C |

As shown in Table 2, the polyolefin microporous membranes of the examples having a structure in which plural porous layers, having a specific structure including a rod-shaped crystal and plural plate-shaped crystals spaced apart from each other and connected to the rod-shaped crystal, are layered, and the plural porous layers are arranged so that the axial directions of the rod-shaped crystals in the respective layers intersect each other, exhibit an excellent gel-like foreign matter removal performance, and the occurrence of clogging due to foreign matter is suppressed.

In contrast, in the polyolefin microporous membranes of the comparative examples, not only was gel-like foreign matter removal inadequate, but clogging due to foreign matter also occurred frequently.

The disclosure of Japanese Patent Application No. 2018-204441, filed on Oct. 30, 2018, is incorporated herein by reference in its entirety.

All documents, patent applications, and technical standards described in the present specification are incorporated by reference in the present specification to the same extent as if the individual documents, patent applications, and technical standards were specifically and individually stated to be incorporated by reference.

1. A polyolefin microporous membrane, comprising:
a first porous layer containing a polyolefin and having a structure including a first rod-shaped crystal extending in one direction and a plurality of first plate-shaped crystals arranged in a separated state and intersecting the first rod-shaped crystal; and
a second porous layer containing a polyolefin and having a structure including a second rod-shaped crystal extending in another direction intersecting the one direction and a plurality of second plate-shaped crystals arranged in a separated state and intersecting the second rod-shaped crystal.

2. The polyolefin microporous membrane according to claim 1, wherein an average flow pore diameter is from 20 nm to 300 nm.

3. The polyolefin microporous membrane according to claim 1, comprising a layered structure including at least the first porous layer and the second porous layer, the second porous layer being disposed at both faces of the first porous layer.

4. The polyolefin microporous membrane according to claim 1, wherein the structure of the first porous layer and the second porous layer comprises a shish-kebab structure including an extended-chain crystal, which is a rod-shaped crystal extending in an axial direction, and a plurality of folded-chain crystals apposed in a separated state and intersecting the extended-chain crystal.

5. The polyolefin microporous membrane according to claim 1, wherein:
the one direction is a width direction perpendicular to a machine direction, and the other direction is the machine direction; and
a ratio of tensile strength in the machine direction relative to tensile strength in the width direction is from 0.10 to 0.99.

6. The polyolefin microporous membrane according to claim 1, wherein a flow rate when passing ethanol through the membrane in a thickness direction is from 10 ml/min/cm² to 300 ml/min/cm² as converted under a pressure of 1 MPa.

7. The polyolefin microporous membrane according to claim 1, having a thickness of from 5 μm to 200 μm.

8. The polyolefin microporous membrane according to claim 1, having a Gurley value of from 0.1 sec/100 ml to 200 sec/100 ml.

9. The polyolefin microporous membrane according to claim 1, having a porosity of from 55% to 85%.

10. The polyolefin microporous membrane according to claim 1, being a base material for a liquid filter.

11. A liquid filter, comprising the polyolefin microporous membrane according to claim 1.
